(19) United States
(12) Patent Application Publication
(10) Pub. No.: US 2010/0175712 A1
(43) Pub. Date: Jul. 15, 2010

(54) SHOWERHEAD CLEANING RACK AND AN ULTRASONIC CLEANING METHOD THEREFOR

(75) Inventors: JR YUAN HUANG, TAIPEI CITY (TW); CHIA FU HSU, TAOYUAN COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: INOTERA MEMORIES, INC., TAOYUAN COUNTY (TW)

(21) Appl. No.: 12/428,042

(22) Filed: Apr. 22, 2009

(30) Foreign Application Priority Data
Jan. 12, 2009 (TW) 98100911

(51) Int. Cl. B08B 3/12

(52) U.S. Cl. 134/1; 134/169 R

(57) ABSTRACT

A showerhead cleaning rack is disclosed. The showerhead cleaning rack includes a frame and a support body, wherein the support body is located and connected with the frame. The support body has a plurality of positioning parts. The positioning parts are used for holding the showerhead. The showerhead cleaning rack is used in an ultrasonic cleaning trough. By utilizing the oscillation of the ultrasonic wave generated in the ultrasonic cleaning trough, the pollutants on the showerhead is cleaned. An ultrasonic cleaning method with the showerhead cleaning rack is also provided.

### BACKGROUND OF THE INVENTION

1. Field of the Invention

The present invention relates to a cleaning rack and a cleaning method with the cleaning rack; in particular, the present invention relates to a showerhead cleaning rack and an ultrasonic cleaning method with the showerhead cleaning rack.

2. Description of Related Art

Integrated circuits usually are manufactured by the deposition processes and the etching processes. The deposition layer is deposited on a working piece. Next, the material of the deposition layer is etched to form a desired pattern. The above manufactured processes are implemented in a vacuum room.

Usually, the chemical reactants for the deposition or etching process includes one or more than one gas (referred to as the manufacturing process gas) and the manufacturing process gas is sprayed in the vacuum room by the showerhead located above the working piece. The manufacturing process gas is sprayed through the small holes located on the surface of the showerhead so as to form the desired manufacturing process gas disposition around the working piece.

When the deposition or etching process is finished, the showerhead needs to be cleaned so as to eliminate the pollutants in the showerhead. Thereby, when the deposition or etching process is performed again, the yield rate of the deposition or etching process will not be affected by the pollutants on the showerhead. Generally, when the showerhead is cleaned, the showerhead is placed in a clean trough that is fully filled with the cleaning agent, and an oscillation method is used to oscillate the cleaning agent so as to clean the pollutants on the showerhead. However, the cleaning method of the prior art cannot fully clean the pollutants. Therefore, the onsite engineer in the semiconductor factory must repeatedly clean the showerhead until the pollutants on the showerhead are fully removed. A lot of cleaning time and manpower are required, thus the production efficiency is affected.

### SUMMARY OF THE INVENTION

One particular aspect of the present invention is to provide a showerhead cleaning rack used in a ultrasonic cleaning trough. When the cleaning process is performed, the showerhead cleaning rack secures the showerhead to a specific location that intersects with the standing wave of an ultrasonic wave in the ultrasonic cleaning trough, and utilizes the energy of the standing wave to forcedly oscillate and clean the pollutants on the showerhead.

Another particular aspect of the present invention is to provide an ultrasonic cleaning method. The ultrasonic cleaning method forms a standing wave. When the showerhead is exactly located at the location that intersects with the standing wave of the ultrasonic wave, the ultrasonic cleaning method utilizes the energy of the standing wave to forcedly oscillate and clean the pollutants on the showerhead.

The showerhead cleaning rack is installed in an ultrasonic cleaning trough for holding and securing a showerhead. The showerhead cleaning rack includes a frame and at least one support body, wherein the support body is located in the frame and connected with the frame. A plurality of positioning parts with a predetermined height protrudes from the support body. The plurality of positioning parts clamps the showerhead to make the showerhead be located at the predetermined height in the ultrasonic cleaning trough, wherein the predetermined height in the ultrasonic cleaning trough is a location that intersects with the standing wave of an ultrasonic wave. When the ultrasonic cleaning trough generates the ultrasonic wave, the ultrasonic wave oscillates and cleans the pollutants on the showerhead.

In one preferred embodiment, the ultrasonic cleaning trough has an ultrasonic wave generator, and the ultrasonic wave generator generates a plurality of standing waves in the ultrasonic cleaning trough. The frame is located at the ultrasonic wave generator, and the predetermined height of the positioning parts results in the showerhead being located at a location that intersects with the standing waves of an ultrasonic wave formed in the ultrasonic cleaning trough.

In one preferred embodiment, the positioning part is an L-shaped rod that protrudes from the support body, and each of the positioning parts has a supporting portion and a holding portion. The supporting portion is adjacent to the holding portion. The supporting portion contacts one side surface of the showerhead, and the holding portion holds the showerhead. A protection part is located at the positioning part. The protection part is L-shaped and is pasted on the supporting portion and the holding portion so as to prevent the positioning part from scraping the surface of the showerhead.

The present invention also provides an ultrasonic cleaning method with the showerhead cleaning rack. The ultrasonic cleaning trough has an ultrasonic wave generator. The ultrasonic cleaning method includes the following steps. A location to be cleaned for the showerhead is determined. The frequency of the ultrasonic wave is determined according to the location to be cleaned. The showerhead is installed at the showerhead cleaning rack and the showerhead is located at a pre-determined height in the ultrasonic cleaning trough. A cleaning agent is added into the ultrasonic cleaning trough, and the ultrasonic wave generator is operated to generate an ultrasonic wave. The ultrasonic wave forms a plurality of standing waves in the cleaning agent. The pre-determined height of the showerhead intersects with the standing waves of the ultrasonic wave. The standing waves oscillate so as to clean the pollutants on the showerhead.

In one preferred embodiment, the cleaning agent is deionized water (DI water), and the standing waves is located at ¼ wavelength and ¾ wavelength of the ultrasonic wave.

The showerhead cleaning rack and the ultrasonic cleaning method with the showerhead cleaning rack have the following characteristics.

The showerhead is installed in the showerhead cleaning rack. The pollutants accumulated on the showerhead can be easily cleaned by the standing waves formed in the ultrasonic cleaning trough. Moreover, by using the showerhead cleaning rack, the showerhead is fastened onto the showerhead cleaning rack when the showerhead is cleaned. Thereby, the showerhead is protected, and the showerhead will not be damaged due to the oscillation generated during the cleaning process.

Furthermore, the present invention utilizes the standing waves formed in the ultrasonic cleaning trough to be the cleaning means, and uses the showerhead cleaning rack to secure the showerhead at a location that intersects with the standing waves. By using the strong oscillation energy of the standing waves, the pollutants on the showerhead is fully cleaned.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

The drawings included herein provide a further understanding of the present invention. A brief introduction of the drawings is as follows:

FIG. 1 is a schematic diagram of a showerhead cleaning rack being located in the ultrasonic cleaning trough of the present invention;

FIG. 2 is a perspective view of the showerhead cleaning rack of the present invention;

FIG. 3A is a perspective view of the showerhead cleaning rack according to a second embodiment of the present invention;

FIG. 3B is a perspective view of the showerhead cleaning rack according to a third embodiment of the present invention;

FIG. 4 is a flow chart of the ultrasonic cleaning method of the present invention; and

FIG. 5 is a schematic diagram of the wave-form position of a standing wave of the present invention.

### DETAILED DESCRIPTION OF THE PREFERRED EMBODIMENTS

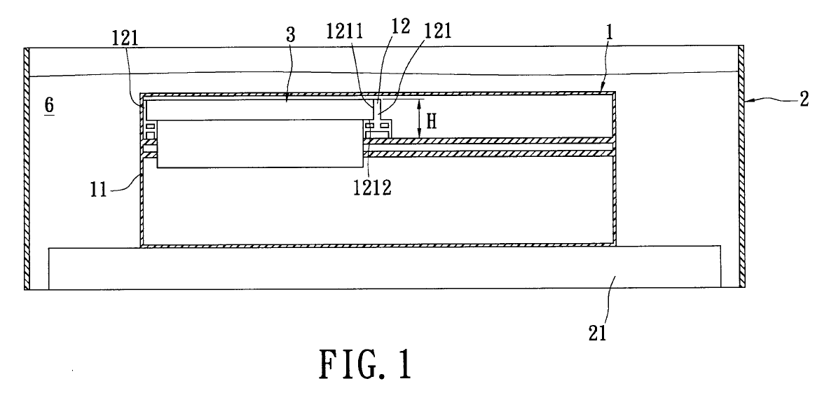

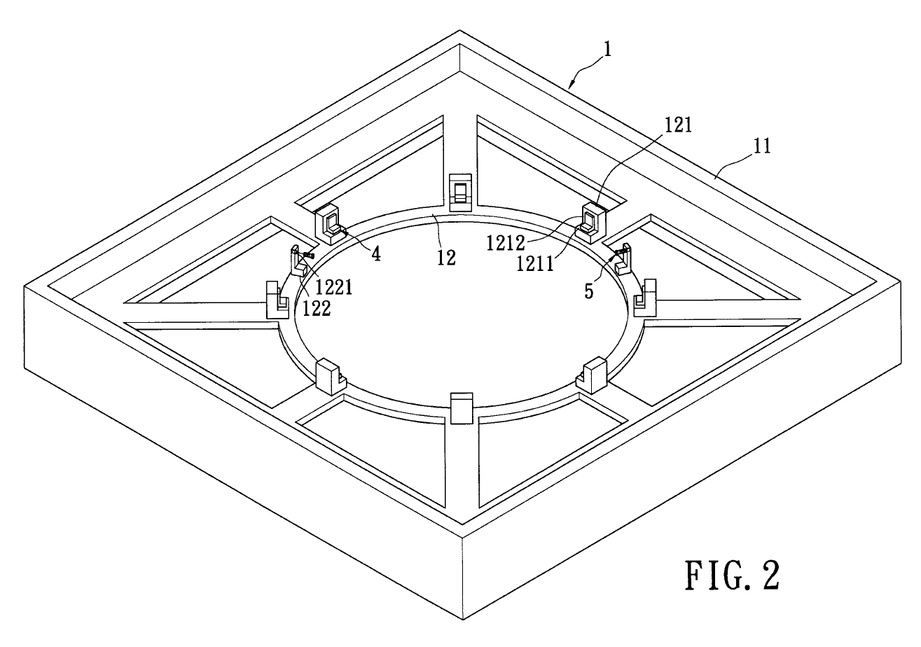

Reference is made to FIGS. 1 and 2. The present invention provides a showerhead cleaning rack. The showerhead cleaning rack 1 is used in an ultrasonic cleaning trough 2 for holding and securing a showerhead 3. By performing a cleaning operation on the showerhead 3 in the ultrasonic cleaning trough 2, the pollutants on the showerhead 3 is cleaned. The showerhead cleaning rack 1 includes a frame 11 and a support body 12 connected with the frame 11. The ultrasonic cleaning trough 2 has an ultrasonic wave generator 21. By generating a ultrasonic wave from the ultrasonic wave generator 21 in the ultrasonic cleaning trough 2, the pollutants on the showerhead 3 is cleaned by oscillation of the ultrasonic wave. The showerhead 3 is used for a plasma-enhanced chemical vapor deposition system (PECVD).

The support body 12 is located in the frame 11, and the support body 12 is connected with the frame 11. The connection between the support body 12 and the frame 11 can be integrated into one piece or be independently connected. In this embodiment, the support body 12 is connected with the wall surface of the frame 11 and is integrated into one piece. The dimension of the support body 12 is smaller than the dimension of the frame 11. The shape of the support body 12 is not limited to a specific one, and can be any shapes, such as circular, square, or irregular. The shape of the support body 12 corresponds to the shape of the showerhead 3. In this embodiment, the shape of the showerhead 3 is circular, and the shape of the support body 12 is also circular.

In order to fasten the showerhead 3, the support body 12 has a plurality of positioning parts 121. The plurality of positioning parts 121 protrude from the support body 12 and are rods. The rods are L-shaped. By holding the showerhead 3 by the plurality of positioning parts 121, the showerhead 3 is fastened and thereby secured. Because the positioning part 121 has a pre-determined height H, the showerhead 3 is kept in the pre-determined height at the support body 12 (as shown in FIG. 1) when the showerhead 3 is held by the plurality of positioning parts 121. The frame 11 is located at the ultrasonic wave generator 21 in the ultrasonic cleaning trough 2. When the ultrasonic wave generator 21 generates ultrasonic waves, the ultrasonic waves form standing waves in the ultrasonic cleaning trough 2. The pre-determined height H is to make the showerhead 3 be at a position that intersects with the standing waves of the ultrasonic waves in the ultrasonic cleaning trough 2 by using the positioning parts 121. By utilizing the standing waves, the pollutants on the showerhead 3 are cleaned.

The positioning part 121 has a support portion 1211 and a holding portion 1212. The support portion 1211 is adjacently connected with and vertical to the holding portion 1212. The support portion 1211 is used for supporting the showerhead 3. The support portion 1211 contacts one side surface of the showerhead 3. The holding portion 1212 is used for securing the showerhead 3. The holding portion holds around the showerhead 3 (referring to the FIG. 1).

In order to protect the showerhead 3, the positioning part 121 also has a protection part 4. The material of the protection part 4 is Teflon. The shape of the protection part 4 corresponds to the shape of the positioning part 121 and is L-shaped. The protection part 4 is pasted on the support portion 1211 and the holding portion 1212 of the positioning part 121. Thereby, when the showerhead 3 is held on to the positioning parts 121, the protection part 4 prevents the showerhead 3 from being scratched by the positioning parts 121.

The support body 12 further has two position-limiting parts 122. The two position-limiting parts 122 are used for fastening the showerhead 3 with the positioning parts 121 so as to prevent the showerhead 3 from escaping the positioning parts 121 when the showerhead 3 is cleaned. The two position-limiting parts 122 protrude from the support body 12 and are L-shaped boards. The two position-limiting parts 122 respectively have a screw hole 1221. When the positioning parts 121 are held around the showerhead 3, a screw 5 is locked into the screw holes 1221 of the two position-limiting parts 122 so as to prevent the showerhead 3 from taking off. The quantity of the position-limiting part 122 is not limited, and can be one, two, three, or more. In this embodiment, the quantity of the position-limiting part 122 is two.

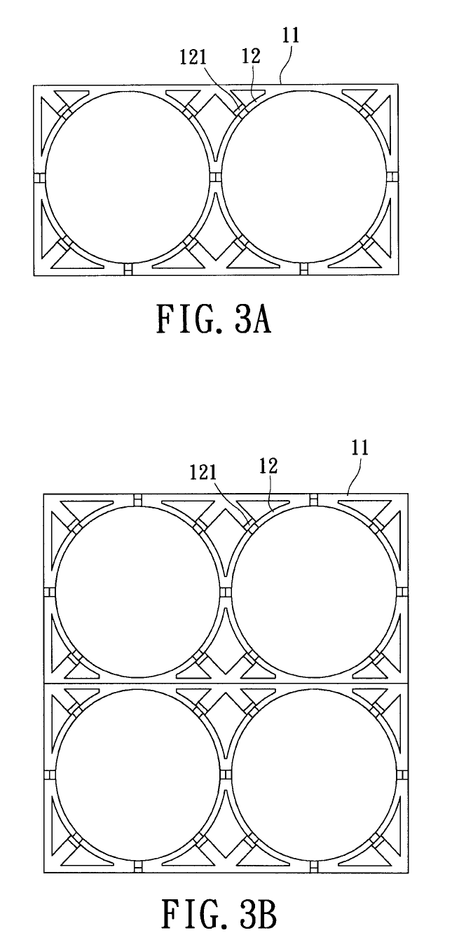

Referring to FIGS. 3A and 3B, the quantity of the support body 12 is also not limited to a specific one, and can be one, two, or more. The frame 11 can be connected with a plurality of support bodies 12, and the plurality of support bodies 12 are installed with a plurality of showerheads 3.

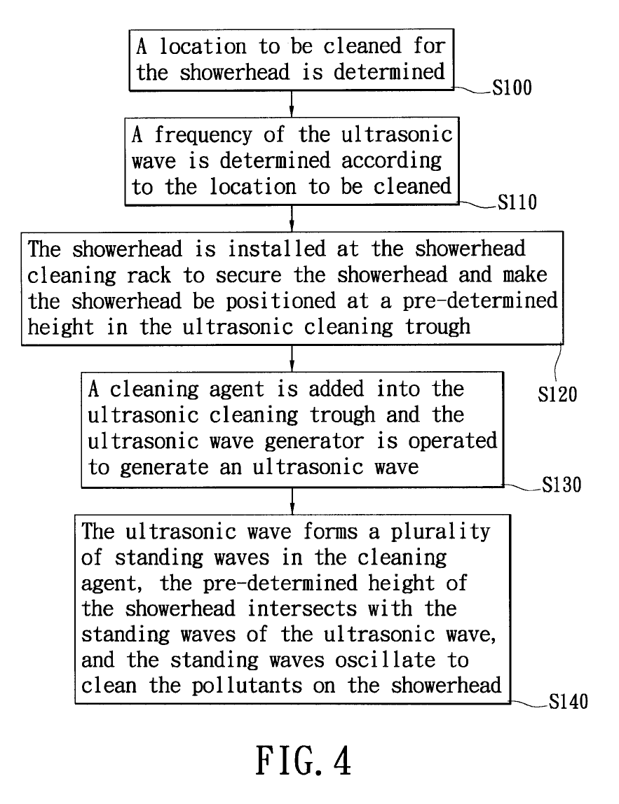

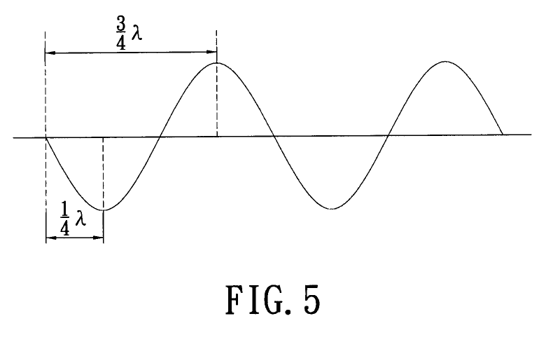

Reference is made to FIG. 4, in conjunction to FIGS. 1 and 2, the present invention also provides an ultrasonic cleaning method with the showerhead cleaning rack 1. The method is applied in the ultrasonic cleaning trough 2. In the ultrasonic cleaning trough 2, there is an ultrasonic wave generator 21. The ultrasonic cleaning method includes the following steps.

S100: A location to be cleaned for the showerhead 3 is determined. The location to be cleaned is the location of the pollutants at the showerhead 3.

S110: The frequency of the ultrasonic wave is determined according to the location to be cleaned for the showerhead 3. The frequency of the ultrasonic wave is not limited to a specific one, and is determined by the location to be cleaned for the showerhead 3.

S120: After the frequency of the ultrasonic wave is determined, the showerhead 3 is installed at the showerhead cleaning rack 1 and the showerhead 3 is located at a pre-determined height H in the ultrasonic cleaning trough 2.

S130: A cleaning agent 6 is added into the ultrasonic cleaning trough 2 and the ultrasonic wave generator 21 in the ultrasonic cleaning trough 2 is operated to generate ultrasonic waves. The type of the cleaning agent 6 is not limited to a specific one, and is determined by the user's requirements. In this embodiment, the cleaning agent 6 is deionized water (DI water).

S140: When the ultrasonic wave generator 21 in the ultrasonic cleaning trough 2 is operated to generate ultrasonic waves, the ultrasonic waves form a plurality of standing waves in the cleaning agent 6. The pre-determined height H of the showerhead 3 is a location that intersects with the standing waves of the ultrasonic waves. The standing waves oscillate to clean the pollutants on the showerhead 3. According to the theory of the standing wave, the standing wave may be located at ¼ and ¾ of the wavelength of the ultrasonic wave.

The showerhead cleaning rack and the ultrasonic cleaning method with the showerhead cleaning rack have the following characteristics.

1. By using the showerhead cleaning rack, the pollutants on the showerhead 3 can be easily cleaned by the standing waves formed in the ultrasonic cleaning trough 2.

2. By using the showerhead cleaning rack, the showerhead 3 is fixed and secured at the showerhead cleaning rack 1 so as to prevent the showerhead 3 from being damaged.

3. The ultrasonic cleaning method of the present invention forms the standing waves in the ultrasonic cleaning trough 2. By utilizing the standing waves as a cleaning means and using the showerhead cleaning rack 1 so that the showerhead 3 is secured at a location that intersects with the standing waves of the ultrasonic waves, the powerful energy of the standing waves are used for cleaning the pollutants on the showerhead 3.

The description above only illustrates specific embodiments and examples of the present invention. The present invention should therefore cover various modifications and variations made to the herein-described structure and operations of the present invention, provided they fall within the scope of the present invention as defined in the following appended claims.

What is claimed is:

1. A showerhead cleaning rack, installed in an ultrasonic cleaning trough for holding and securing a showerhead, comprising:
a frame; and
at least one support body located in the frame and connected with the frame, wherein a plurality of positioning parts with a predetermined height protrudes from the support body, the plurality of positioning parts clamps the showerhead so that the showerhead is located at the predetermined height in the ultrasonic cleaning trough, and when the ultrasonic cleaning trough generates ultrasonic waves, the ultrasonic waves oscillate and cleans the pollutants on the showerhead.

2. The showerhead cleaning rack as claimed in claim 1, wherein the ultrasonic cleaning trough has an ultrasonic wave generator, and the ultrasonic wave generator generates the ultrasonic waves with a plurality of standing waves in the ultrasonic cleaning trough at intervals.

3. The showerhead cleaning rack as claimed in claim 2, wherein the frame is located at the ultrasonic wave generator, and the predetermined height of the positioning part that holds the showerhead is a location that intersects with the standing waves of the ultrasonic waves in the ultrasonic cleaning trough.

4. The showerhead cleaning rack as claimed in claim 1, wherein the dimension of the support body is smaller than the dimension of the frame.

5. The showerhead cleaning rack as claimed in claim 1, wherein the support body is connected with the frame and is integrated into one piece.

6. The showerhead cleaning rack as claimed in claim 1, wherein the shape of the support body corresponds to the shape of the showerhead.

7. The showerhead cleaning rack as claimed in claim 1, wherein the plurality of positioning parts protrudes from the support body and are L-shaped rods.

8. The showerhead cleaning rack as claimed in claim 7, wherein each of the positioning parts has a support portion and a holding portion, the support portion is adjacently connected with the holding portion, the support portion contacts one side surface of the showerhead, and the holding portion holds around the showerhead.

9. The showerhead cleaning rack as claimed in claim 8, wherein the positioning part further has a protection part, and the protection part is L-shaped and is pasted onto the support portion and the holding portion so as to prevent the surface of the showerhead from being scratched by the positioning part.

10. The showerhead cleaning rack as claimed in claim 9, wherein the material of the protection part is Teflon.

11. The showerhead cleaning rack as claimed in claim 1, wherein the support body further has at least one position-limiting part, the position-limiting part is integrated with the support body and protrudes from the support body, the position-limiting part has a screw hole, and when the plurality of positioning parts hold around the showerhead, at least one screw is locked into the screw hole so as to prevent the showerhead from taking off from the positioning part when the showerhead is cleaned.

12. The showerhead cleaning rack as claimed in claim 1, wherein the showerhead is used for a plasma-enhanced chemical vapor deposition system.

13. An ultrasonic cleaning method with the showerhead cleaning rack as claimed in claim 1, wherein a ultrasonic cleaning trough has an ultrasonic wave generator, the ultrasonic cleaning method comprising:
determining a location to be cleaned for the showerhead;
determining a frequency of the ultrasonic wave according to the location to be cleaned;
installing the showerhead at the showerhead cleaning rack so that the showerhead is located at a pre-determined height in the ultrasonic cleaning trough;
adding a cleaning agent into the ultrasonic cleaning trough and operating the ultrasonic wave generator to generate an ultrasonic wave; and
forming a plurality of standing waves in the cleaning agent by the ultrasonic wave, wherein the pre-determined height of the showerhead is a location that intersects with the standing waves of the ultrasonic wave, and the standing waves oscillate to clean the pollutants on the showerhead.

14. The ultrasonic cleaning method as claimed in claim 13, wherein the cleaning agent is deionized water.

15. The ultrasonic cleaning method as claimed in claim 13, wherein the standing wave is located at ¼ and ¾ wavelength of the ultrasonic wave.
